(19) United States
(12) Patent Application Publication
(10) Pub. No.: US 2015/0052682 A1
(43) Pub. Date: Feb. 26, 2015

(54) ELONGATE BODY SUPPORTING DEVICE

(71) Applicant: Compact Innovation Limited, London (GB)

(72) Inventors: Benjamin Biswell, London (GB); Stephen Marshall-Rees, London (GB); Guy Wilson, London (GB)

(21) Appl. No.: 14/388,148

(22) PCT Filed: Mar. 26, 2013
(86) PCT No.: PCT/GB2013/000132

§ 371 Date: Sep. 25, 2014

(30) Foreign Application Priority Data
Mar. 28, 2012 (GB) 1205483.9

(51) Int. Cl. A47C 19/12; A61G 1/013; A47C 4/28

(52) U.S. Cl. CPC A47C 19/122; A47C 4/28; A61G 1/013
USPC 5/627; 297/452.2; 5/111

(57) ABSTRACT

A foldable elongate body supporting device comprising an elongate body supporting surface (1) formed of a flexible material and comprising a plurality of linearly aligned support sections (1a) to (1e), each support section having secured on opposed sides a rigid tube (3) extending in the longitudinal direction of the device, the tubes (3) on each side of the sections being axially aligned, a space (4) being formed between each of the aligned tubes and the aligned tube of the adjacent section. A locking member (5) is slidably located in and extending through the aligned tubes on (3) each side of the device, the locking member (5) comprising a plurality of rigid locking tubes (6) each adapted to the movable into a locking position overlapping the spaces (4) between adjacent aligned tubes (3). The locking tubes (6) are joined by hinges (7). The locking tubes (6) are movable longitudinally relative to the aligned tubes (3) between a locking position, in which the rigid tubes (6) overlap the spaces between the adjacent rigid tubes to form a rigid side member on each side of the device, and a folding position in which the hinges are aligned with the spaces between the aligned tubes to enable the support sections to be pivoted to a folded position.

The present invention relates to an elongate body supporting device in the form, for example, of a sun lounger, camp bed or stretcher which is adapted to be folded up to a compact size for easy storage and transportation.

Many forms of foldable sun lounger, campbed, chair or stretcher are known, but the known devices have failed to provide a complete answer to the conflicting problems of providing a product which is both durable and rigid in use but at the same time is easily foldable and extendable between a closed position and an extended operational position.

The known devices used a variety of hinges to enable the various parts of the device twofold relative to each other but these hinges are either very substantial and complex or relatively flimsy and can easily be damaged by the ingress of the foreign matter such as sand on a beach. Furthermore, the known products utilise clips, locks, detent pins and the like to secure the product in the extended operational position. These products invariably mean that the extension and folding of the device takes time and a degree of skill in ensuring that all locking devices are clearly in place. The known locking means are also susceptible to damage in the same manner as the hinges.

The present invention seeks to provide a solution to these problems.

According to the present invention there is provided a foldable elongate body supporting device comprising an elongate body supporting surface formed of a flexible material and comprising a plurality of linearly aligned support sections, each support section having secured on opposed sides a rigid tube extending in the longitudinal direction of the device, the rigid tubes on each side of the sections being axially aligned, a space being formed between each of the aligned rigid tubes and the aligned rigid tube of the adjacent section, a locking member being slidably located in and extending through the aligned rigid tubes on each side of the device, the locking member comprising a plurality of rigid locking tubes each adapted to be movable into a locking position overlapping the spaces between adjacent aligned rigid tubes, adjacent locking tubes being joined by hinges, the locking members being movable longitudinally relative to the aligned rigid tubes between a locking position, in which the locking tubes overlap the spaces between the adjacent aligned rigid tubes to form a rigid side member on each side of the device, and a folding position in which the hinges are aligned with the spaces between the aligned rigid tubes to enable the support sections to be pivoted to a folded position.

Preferably, each locking member is movable between the locking and folding positions by holding the device substantially vertically to allow the member to fall to the locking position, or folding position, in dependence upon which end of the stretcher is held up.

In an alternative embodiment, the locking member is movable by manually operable means.

Preferably, the rigid tubes and/or locking tubes are formed of a lightweight metal, such as an aluminium alloy.

In a preferred embodiment, the hinges joining the locking tubes comprise a close wound coil spring.

In one form, the locking tubes of each locking member are formed of a plastics material in which case, the hinges may be formed by film hinges.

Preferably, the support sections of the device are foldable in a fanfold manner.

Preferably, the tubes may be cylindrical or substantially square in cross section.

A preferred embodiment of the device includes a plurality of legs each in the form of a spreader extending between and being hingedly connected between the opposed aligned tubes of an associated one of said surface sections so as to be foldable between a closed position abutting the underside of the support surface and an extended ground supporting position to hold the supporting surface clear of the ground.

Preferred embodiments of the invention will now be described by way of example, with reference to the accompanying drawings in which:—

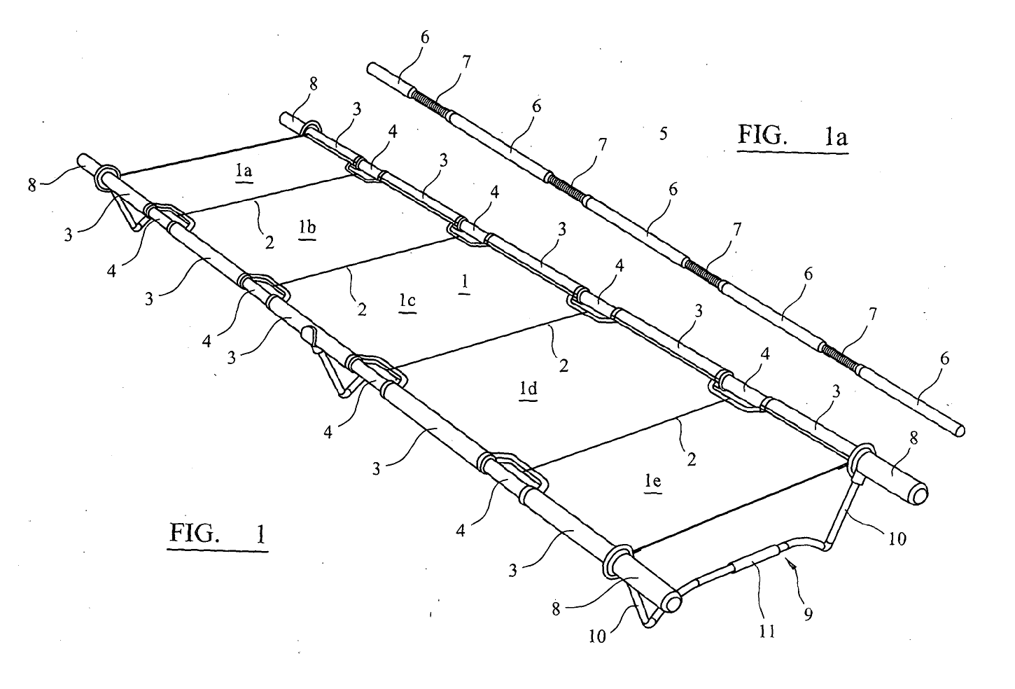

FIG. 1 shows a perspective view of a stretcher,

FIG. 1a shows a perspective view of a locking member,

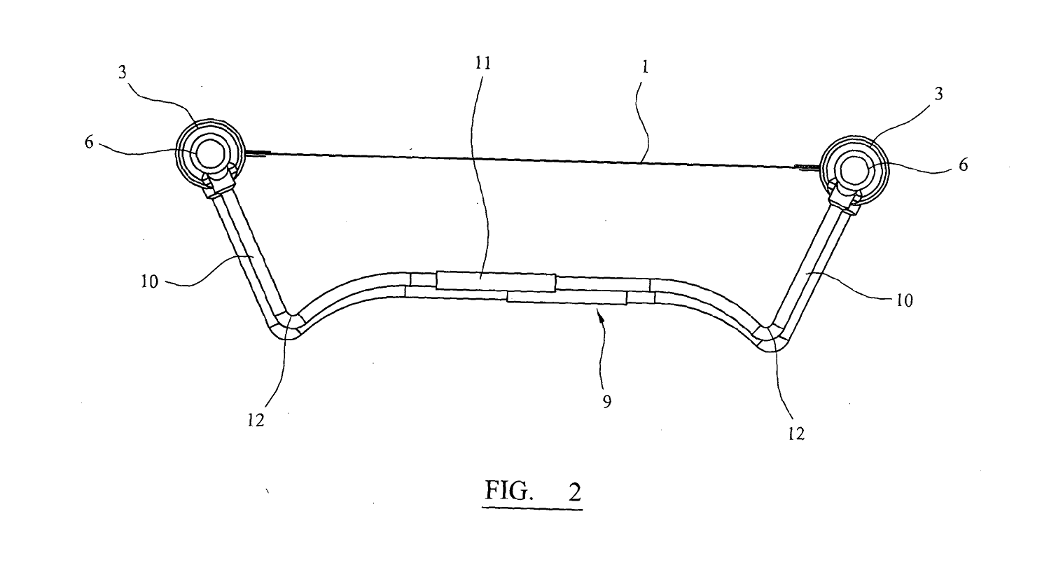

FIG. 2 shows an end view of the stretcher with the legs in an extended position,

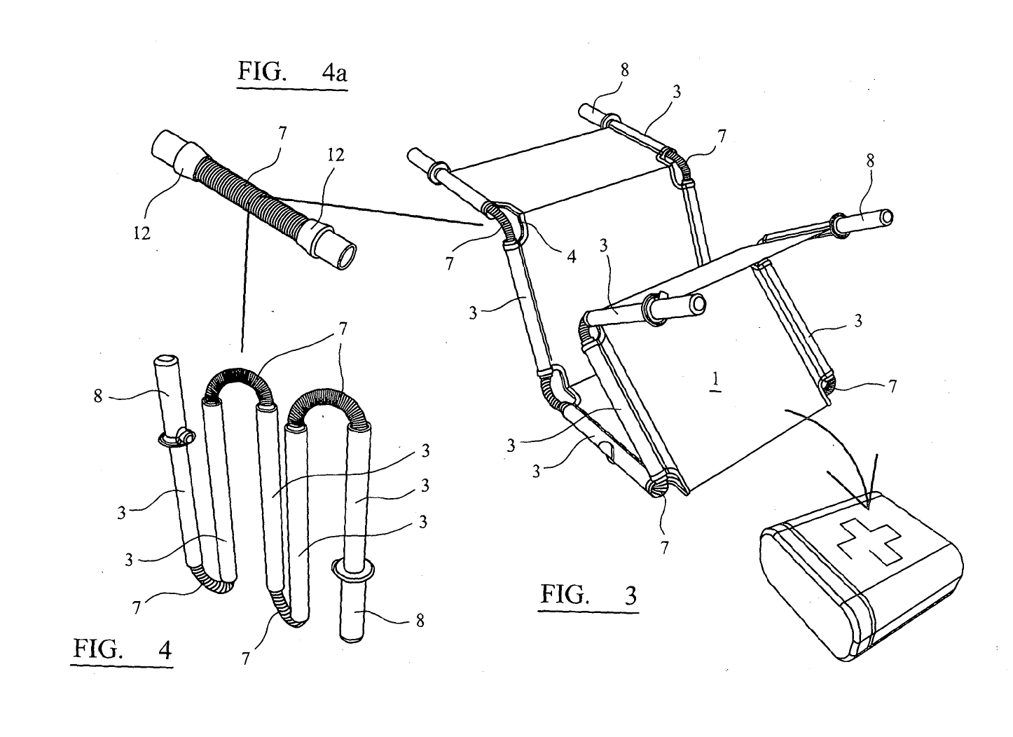

FIG. 3 shows the stretcher in a half folded position,

FIG. 4 is a schematic view of the locking member and side tubes of the stretcher,

FIG. 4a shows a hinge in the form of a close coiled coil spring,

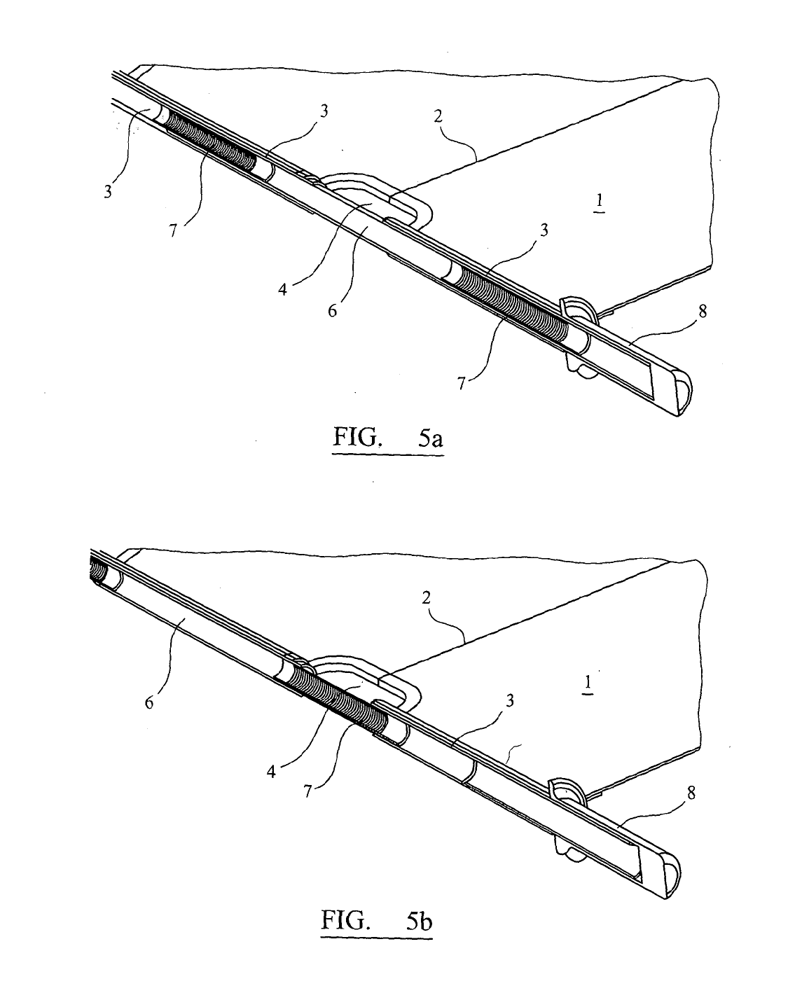

FIG. 5a shows the stretcher locked in the extended position, and

FIG. 5b shows the locking member in a position to enable the stretcher to be folded.

Referring to FIG. 1, there is shown a stretcher having a body supporting surface formed of a single sheet of a flexible material, divided into five sections 1a to 1e so as to be foldable in a fanfold manner about fold lines 2 into a compact folded position, as described hereinafter. Each section 1a-1e has secured to opposite side edges thereof a rigid tube 3 formed of a rigid material such as a light weight metal, typically an aluminium alloy, the tubes 3 on each side of the stretcher being axially aligned with a space 4 being formed between the tubes 3 in the region of the fold line 2 about which the sections of the stretcher are folded. The tubes may be formed of alternative materials such as steel, titanium, carbon fibre, reinforced plastics, alloys or composite materials with the objective of providing a sufficiently strong and durable product which is also as light as possible.

Referring now to FIG. 1 a also, there is showing a locking member 5 which in the assembled position passes through all of the aligned rigid tubes 3 on one side of the stretcher, one locking member 5 being provided on each side. The locking member 5 consists of a plurality of rigid locking tubes 6 which are joined by hinges, in the form of flexible members which in this embodiment comprise close coiled coil springs 7, to secure all the locking tubes 6 together. The dimensions of the locking tubes 6 and the coil springs 7 are such that the locking member 5 is slidable longitudinally through the aligned rigid tubes 3 on each side of the stretcher between a locked position in which the locking tubes 6 are aligned with the spaces 4 between the tubes 3 in adjacent sections, and a folding position in which the coil springs 7 are aligned with the gaps between adjacent side tubes 3. The dimensions of the locking tubes 6 are chosen so that the locking member can moved longitudinally to and fro to abut respective stops in the handles 8 at each end of the stretcher, one defining the locking position and the other defining the folding position.

As shown also in FIG. 2, the stretcher incorporates three legs 9 in the form of a spreader bars which extend across the stretcher and have leg sections 10 hingedly connected to opposed side tubes 3 of the stretcher and being joined at their ends remote from the hinge to a stretcher bar 11 which maintains the supporting surface 1 of the stretcher in a stretched position. As shown, the spreader bar 11 is an elongate tubular member extending downwardly towards the point 12 where it joins the legs so that the ground engagement takes place at essentially point contact at the point shown. The legs are thus pivotable from the operational ground engagement position shown in FIG. 2 to a folded position in which they lie substantially adjacent to the underside of the support surface 1. In one form of the stretcher, the spreader bar 11 has means to enable the spreader bar 11 to be reduced in its longitudinal dimension to facilitate stowage and transport by enabling the stretcher to be collapsed laterally. For example, it could be telescopic with a locking arrangement such as spring loaded detent pins or a bayonet fastening arrangement movable to a locking position by pivoting a section of the stretcher tube about its axis. Alternatively, the stretcher bar may be hinged intermediate its length and arranged to be locked by an over-centre locking position.

Referring to FIG. 3, there is shown the stretcher with the locking member 5 in the position where the coil springs 7 are located in the spaces 4 between the rigid tubes 3 to enable the stretcher to be folded in a fanfold manner for packing in a container for easy transport.

FIG. 4 shows schematically the arrangement of the tubes 3, 6 and hinges 7 when the stretcher is folded in the fanfold manner for transportation. The figure shows the side tubes 3 incorporating the stretcher handles 8 at each end with the hinges 7 in their folded position. FIG. 4a shows a detail of the coil spring 7 which is secured at each end to connecting flanges 12 to which the rigid side tubes 3 are secured.

Referring now to FIGS. 5a and 5b, FIG. 5a shows the condition of the locking member 5 in the locking position in which the rigid locking tubes 6 of the locking member 5 are slidable within the outer rigid tube 3 secured to the surface fabric to a position where it overlaps the gap 4 between the aligned rigid tubes 3 to form a rigid side member for the stretcher. In practice, the member is held in the lock position securely by the weight of a person on the stretcher which causes the stretcher to bend slightly. FIG. 5b shows the locking member 5 when the springs 7 are located in the space 4 between the rigid side tubes to enable the stretcher to be folded about the fold line 2 as illustrated.

To move the locking member between the positions as shown in FIGS. 5a and 5b, the stretcher is held in a substantially vertical position and the locking member 5 is shaken down, or allowed to fall down, to the desired position by holding the stretcher up from one end. The locking member 5 can fall under the influence of gravity to the locked position by holding one end of the stretcher up and by holding it at the other end the locking member can fall to the folding position to enable the stretcher to be folded up.

In an alternative form, or additionally, cords may be secured to the respective ends of the locking member and passing out through the handles at the opposite ends of the stretcher to enable the locking member to be moved manually between its two positions with the stretcher in other than a vertical or near vertical position.

Although not shown, it is possible for the gap between adjacent aligned tubes to be closed by a flexible sealing tube to prevent the ingress of foreign matter such as sand into the spring and the interior of the tubes. Furthermore, the handles may be movable to a retracted position within the side tubes for transport or stowage.

Although shown as tubes of cylindrical cross-section, it will be understood that tubes of a generally square cross-section may be used. In an alternative construction, the tubes are formed of a reinforced plastics material, in which case the springs may be replaced by film hinges integral with the rigid tubes. This construction would be more appropriate when square section tubes are used which would prevent the inner and outer tubes twisting rotationally relative to each other. In the embodiment shown in the drawings, the locking member can freely move rotationally relative to the outer tubes and still function correctly by virtue of the use of the close coiled coil springs as the flexible members.

In an alternative embodiment, the legs illustrated in FIG. 2 are each replaced by a pneumatic ground engaging member in the form of a tube extending transversely across the device and inflatable to raise the body supporting surface above the ground. In one form, the 3 tubes are interconnected fluidically by air passages so that only one tube need have an air inlet. The air passages may incorporate one-way valves so that if one tube is punctured air does not escape through the puncture from the other tubes.

It will be appreciated that the number of tubes may vary, typically 2 or 4 tubes being provided. In an alternative construction, Two or more tubes or a single U-shaped tube may extend longitudinally, spaced apart, along substantially the length of the device. The cross-section of the tubes need not be uniform.

1. A foldable elongate body supporting device comprising an elongate body supporting surface formed of a flexible material and comprising a plurality of linearly aligned support sections, each support section having secured on opposed sides a rigid tube extending in the longitudinal direction of the device, the rigid tubes on each side of the sections being axially aligned, a space being formed between each of the aligned rigid tubes and the aligned rigid tube of the adjacent section, a locking member being slidably located in and extending through the aligned rigid tubes on each side of the device, the locking member comprising a plurality of rigid locking tubes each adapted to be movable into a locking position overlapping the spaces between adjacent aligned rigid tubes, adjacent locking tubes being joined by hinges, the locking members being movable longitudinally relative to the aligned rigid tubes between a locking position, in which the locking tubes overlap the spaces between the adjacent aligned rigid tubes to form a rigid side member on each side of the device, and a folding position in which the hinges are aligned with the spaces between the aligned rigid tubes to enable the support sections to be pivoted to a folded position.

2. The body supporting device according to claim 1, wherein each locking member is movable between the locking and folding positions by holding the device substantially vertically to allow the locking member to fall to the locking position, or folding position, in dependence upon which end is held up.

3. The body supporting device according to claim 1, wherein the locking member is movable by manually operable means.

4. The body supporting device according to claim 1, wherein the rigid tubes and/or the locking tubes are formed of lightweight metal.

5. The body supporting device according to claim 1, wherein the hinges joining the locking tubes comprise a close wound coil spring.

6. The body supporting device according to claim 1, wherein the locking tubes of each locking member are formed of a plastics material.

7. The body supporting device according to claim 1, wherein the hinges are formed by film hinges.

8. The body supporting device according to claim 1, wherein the support sections of the device are foldable in a fanfold manner.

9. The body supporting device according to claim 1, wherein the tubes are cylindrical.

10. The body supporting device according to claim 1, wherein the tubes are substantially square in cross section.

11. The body supporting device according to claim 1, and further including a plurality of legs each in the form of a spreader extending between and being hingedly connected between the opposed aligned rigid tubes of an associated one of said surface sections so as to be foldable between a closed position abutting the underside of the support surface and an extended ground supporting position.

12. The body supporting device according to claim 1, and further having at least one pneumatic ground engaging member inflatable to raise the body supporting surface above the ground.
